(19) United States
(12) Patent Application Publication
(10) Pub. No.: US 2026/0098512 A1
(43) Pub. Date: Apr. 9, 2026

(54) INTAKE MANIFOLD

(71) Applicant: TOYOTA BOSHOKU KABUSHIKI KAISHA, Aichi-ken (JP)

(72) Inventors: Ryosuke KATO, Nisshin-shi (JP); Yusuke SUZUKI, Aichi-ken (JP); Naritsune MIYANAGA, Toyota-shi (JP)

(73) Assignee: TOYOTA BOSHOKU KABUSHIKI KAISHA, Aichi-ken (JP)

(21) Appl. No.: 19/346,851

(22) Filed: Oct. 1, 2025

(30) Foreign Application Priority Data
Oct. 7, 2024 (JP) 2024-175910

(51) Int. Cl. F02M 35/104; F02M 35/10

(52) U.S. Cl. CPC F02M 35/104; F02M 35/10308

(57) ABSTRACT

An intake manifold includes a curved passage extending in a curved manner. The curved passage includes a first segmental body and a second segmental body that are separate from each other in a longitudinal direction of the curved passage and are welded together by a weld portion. The weld portion includes a main weld part and an auxiliary weld part. The main weld part annularly extends in a peripheral direction of the curved passage. The auxiliary weld part is arranged on an inner portion of the curved passage with respect to a curvature direction of the curved passage at a position separated from the main weld part in a radially outward direction of the curved passage.

### CROSS-REFERENCE TO REALTED APPLICATIONS

This application is based upon and claims the benefit of priority from Japanese Patent Application No. 2024-175910, filed on October 7, 2024, the entire contents of which are incorporated herein by reference.

### BACKGROUND

### 1. Field

The present disclosure relates to an intake manifold.

### 2. Description of Related Art

JP2020-84926A discloses an intake manifold that supplies intake air to an internal combustion engine. The intake manifold includes a surge tank configured to draw in air and intake pipes extending in a curved manner from the surge tank. An end of each intake pipe is attached to a cylinder head of the internal combustion engine.

The intake pipe includes multiple tubular segmental members that are separate from each other in a longitudinal direction of the intake pipe. The tubular segmental members are welded together.

The intake manifold may receive bending stress caused by, for example, vibration and collision of the vehicle. In the intake manifold described in the above publication, when the intake pipe receives bending stress that acts to decrease the curvature of the intake pipe, the stress is likely to concentrate on an inner portion of the intake pipe with respect of a curvature direction of the intake pipe. As a result, the weld portions of the segmental members may be separated from each other. If the weld portions are separated from each other, the intake pipe communicates with the exterior. This may adversely affect the function of the intake manifold to supply air.

Such an instance is not limited to the intake pipe attached to the cylinder head and may also occur in other portions of the intake manifold extending in a curved manner.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

To solve the problem described above, an intake manifold includes a curved passage extending in a curved manner. The curved passage includes a first segmental body and a second segmental body that are separate from each other in a longitudinal direction of the curved passage and are welded together by a weld portion. The weld portion includes a main weld part annularly extending in a peripheral direction of the curved passage, and an auxiliary weld part arranged on an inner portion of the curved passage with respect to a curvature direction of the curved passage at a position separated from the main weld part in a radially outward direction of the curved passage.

Other features and aspects will be apparent from the following detailed description, the drawings, and the claims.

### BRIEF DESCRIPTION OF THE DRAWINGS

FIG. 1 is a perspective view showing an embodiment of an intake manifold.

FIG. 2 is a cross-sectional view of a curved passage of the intake manifold shown in FIG. 1.

FIG. 3 is an enlarged cross-sectional view of weld portions shown in FIG. 2.

FIG. 4 is a bottom view of a first segmental body of the intake manifold shown in FIG. 1.

FIG. 5 is a plan view of a second segmental body of the intake manifold shown in FIG. 1.

FIG. 6 is a cross-sectional view of the intake manifold taken along line 6-6 in FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms and are not limited to the examples described. However, the examples described are thorough and complete, and convey the full scope of the disclosure to one of ordinary skill in the art.

In this specification, “at least one of A and B” should be understood to mean “only A, only B, or both A and B.”

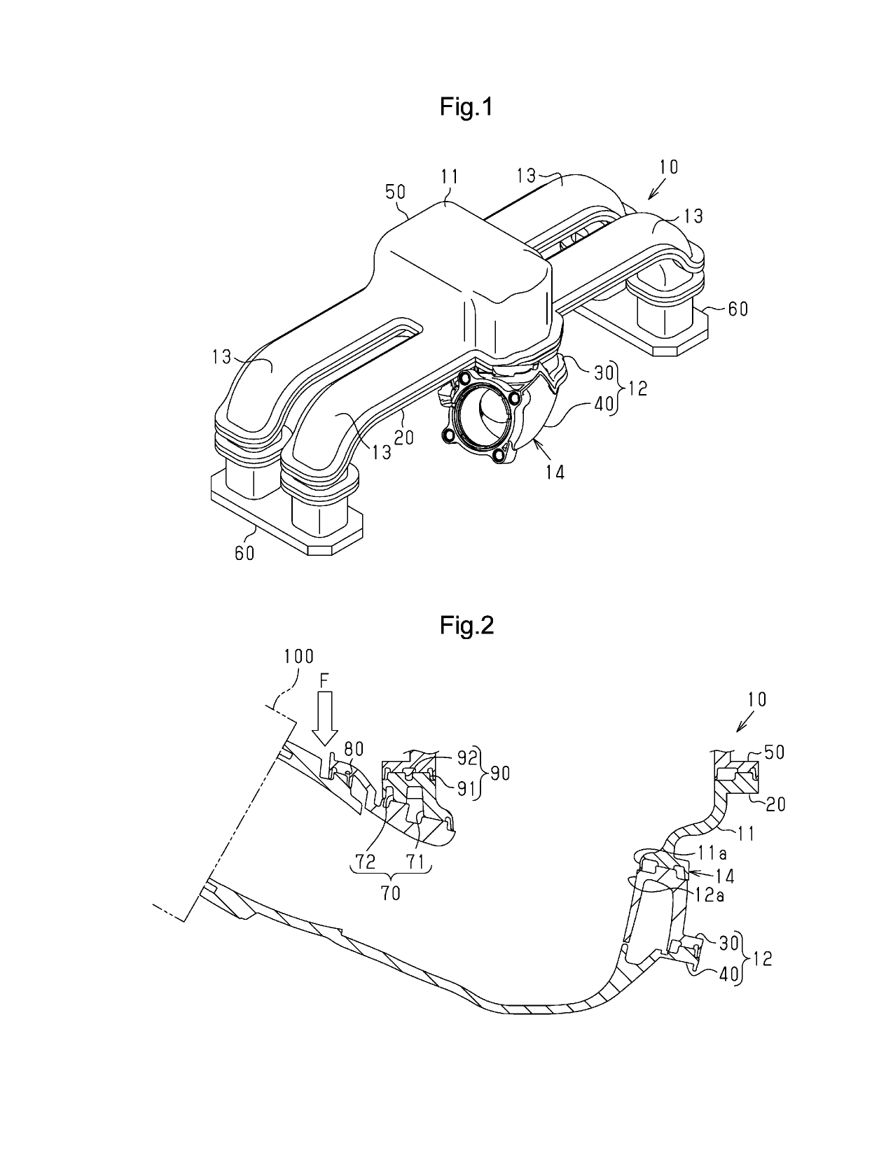

An embodiment of an intake manifold will now be described with reference to FIGS. 1 to 6.

### Overall Structure of Intake Manifold 10

The intake manifold 10 shown in FIG. 1 supplies intake air to, for example, an internal combustion engine of a vehicle having a horizontally-opposed cylinder configuration. The intake manifold 10 is formed from a resin material.

The intake manifold 10 includes a surge tank 11, a guide pipe 12, and multiple segmental pipes 13. The intake manifold 10 includes, for example, four segmental pipes 13.

As shown in FIG. 2, the surge tank 11 includes a guide inlet 11a that draws in air. The guide inlet 11a is open in a bottom wall of the surge tank 11.

The guide pipe 12 extends downward from the surge tank 11 and then is bent obliquely upward. The guide pipe 12 extends from the surge tank 11 in a cantilever manner. The guide pipe 12 has a connection hole 12a connected to the guide inlet 11a. The connection hole 12a is open upward. The guide pipe 12 is connected to a throttle body 100 that incorporates a throttle valve (not shown). The guide pipe 12 guides intake air, flowing in the throttle body 100, to the surge tank 11 through the connection hole 12a.

As shown in FIG. 1, the surge tank 11 includes a first side surface and a second side surface located at opposite sides in a vehicle-width direction. Of the four segmental pipes 13, two segmental pipes 13 extend from the first side surface of the surge tank 11 away from the surge tank 11 in the vehicle-width direction and then are bent downward. The remaining two segmental pipes 13 extend from the second side surface of the surge tank 11 away from the surge tank 11 in the vehicle-width direction and then are bent downward. The segmental pipes 13 each include a lower end connected to an intake port (not shown) of the internal combustion engine.

The intake manifold 10 includes a first segmental body 20, a second segmental body 30, a third segmental body 40, a fourth segmental body 50, and two fifth segmental bodies 60 that are welded together. The first segmental body 20 includes a lower portion of the surge tank 11 and a lower portion of each segmental pipe 13. The second segmental body 30 includes a downstream portion of the guide pipe 12 having the connection hole 12a. The third segmental body 40 includes an upstream portion of the guide pipe 12 connected to the throttle body 100. The fourth segmental body 50 includes an upper portion of the surge tank 11 and an upper portion of each segmental pipe 13. One of the two fifth segmental bodies 60 includes lower ends of the two segmental pipes 13 extending from the first side surface of the surge tank 11. The other one of the two fifth segmental bodies 60 includes lower ends of the two segmental pipes 13 extending from the second side surface of the surge tank 11.

As shown in FIG. 2, the first segmental body 20 and the second segmental body 30 are welded to each other by a weld portion 70. The second segmental body 30 and the third segmental body 40 are welded to each other by a weld portion 80. The first segmental body 20 and the fourth segmental body 50 are welded to each other by a weld portion 90. The first segmental body 20 and the fifth segmental bodies 60 are welded to each other by a weld portion that is not shown.

### Structure of Curved Passage 14

The intake manifold 10 includes a curved passage 14 extending in a curved manner. The curved passage 14 is formed of the surge tank 11 and the guide pipe 12, which bends and extends from the surge tank 11. The curved passage 14 is formed of the first segmental body 20, the second segmental body 30, the third segmental body 40, and the fourth segmental body 50 that are separate in a longitudinal direction of the curved passage 14 and are welded together.

In the curved passage 14, the direction in which intake air flows through the guide pipe 12 differs from the direction in which intake air flows through the surge tank 11. The first segmental body 20 and the second segmental body 30 are separate at a corner of the curved passage 14 where the flow direction of the intake air changes.

### Structure of Weld Portion 70

The weld portion 70 includes a main weld part 71 and an auxiliary weld part 72. The main weld part 71 annularly extends in a peripheral direction of the curved passage 14. The main weld part 71 seals the border between the first segmental body 20 and the second segmental body 30 along the entire perimeter of the curved passage 14. The auxiliary weld part 72 is arranged at a position separated from the main weld part 71 in a radially outward direction of the curved passage 14. The auxiliary weld part 72 is arranged on only an inner portion of the curved passage 14 with respect to a curvature direction of the curved passage 14. The phrase “the inner portion of the curved passage 14 with respect to the curvature direction of the curved passage 14” refers to a portion of the curved passage 14 located at an inner side of a curve defined by the curved passage 14. The auxiliary weld part 72 has a cross section orthogonal to the longitudinal direction of the curved passage 14. The cross section of the auxiliary weld part 72 has the form of a rectangle having rounded corners. The auxiliary weld part 72 joins the first segmental body 20 and the second segmental body 30. The auxiliary weld part 72 does not seal the border between the first segmental body 20 and the second segmental body 30.

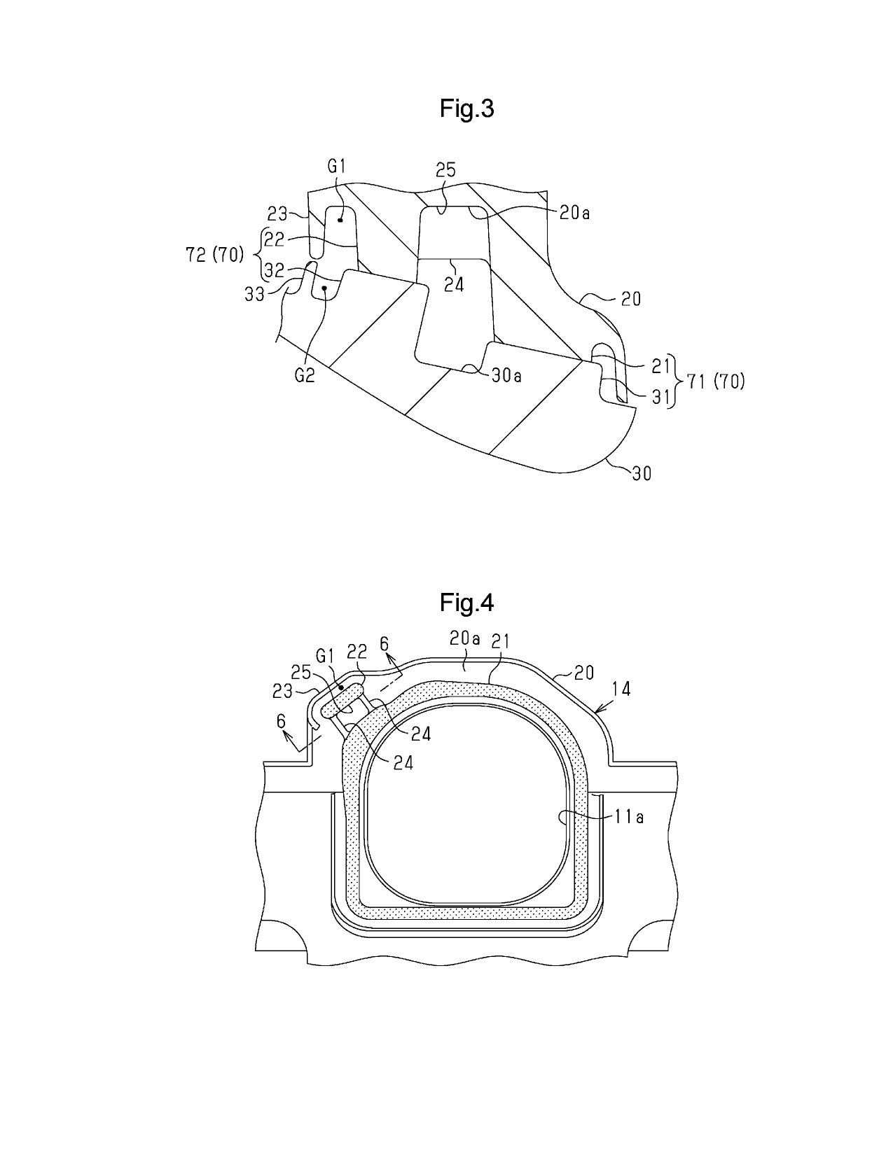

As shown in FIG. 3, the first segmental body 20 includes a first main weld projection 21 forming the main weld part 71 and a first auxiliary weld projection 22 forming the auxiliary weld part 72. The first segmental body 20 includes a peripheral edge 20a extending around the guide inlet 11a. The first main weld projection 21 projects from the peripheral edge 20a toward the second segmental body 30. The first auxiliary weld projection 22 projects from the peripheral edge 20a toward the second segmental body 30. The first main weld projection 21 is an example of a “main weld projection.” The first auxiliary weld projection 22 is an example of a “auxiliary weld projection.”

As shown in FIG. 4, the first main weld projection 21 is annular and extends around the guide inlet 11a. The first auxiliary weld projection 22 is arranged on the inner portion of the curved passage 14 with respect to the curvature direction of the curved passage 14 at a position separated from the first main weld projection 21 in the radially outward direction of the curved passage 14. The first auxiliary weld projection 22 has a cross section orthogonal to the longitudinal direction of the curved passage 14. The cross section of the first auxiliary weld projection 22 has the form of a rectangle having rounded corners and long sides extending in the peripheral direction of the first main weld projection 21. In FIG. 4, dot shading indicates a weld surface of each of the first main weld projection 21 and the first auxiliary weld projection 22.

The first segmental body 20 includes a first peripheral rib 23 covering the first auxiliary weld projection 22 from sideward. The first peripheral rib 23 includes a portion covering the first auxiliary weld projection 22 from the side opposite to the first main weld projection 21 and a portion covering two longitudinal ends of the first auxiliary weld projection 22. The first peripheral rib 23 is not arranged between the first auxiliary weld projection 22 and the first main weld projection 21. The first peripheral rib 23 is entirely separated from the first auxiliary weld projection 22 by a gap G1.

As shown in FIG. 3, the second segmental body 30 includes a second main weld projection 31 forming the main weld part 71 and a second auxiliary weld projection 32 forming the auxiliary weld part 72. The second segmental body 30 includes a peripheral edge 30a extending around the connection hole 12a. The second main weld projection 31 projects from the peripheral edge 30a toward the first segmental body 20. The second auxiliary weld projection 32 projects from the peripheral edge 30a toward the first segmental body 20.

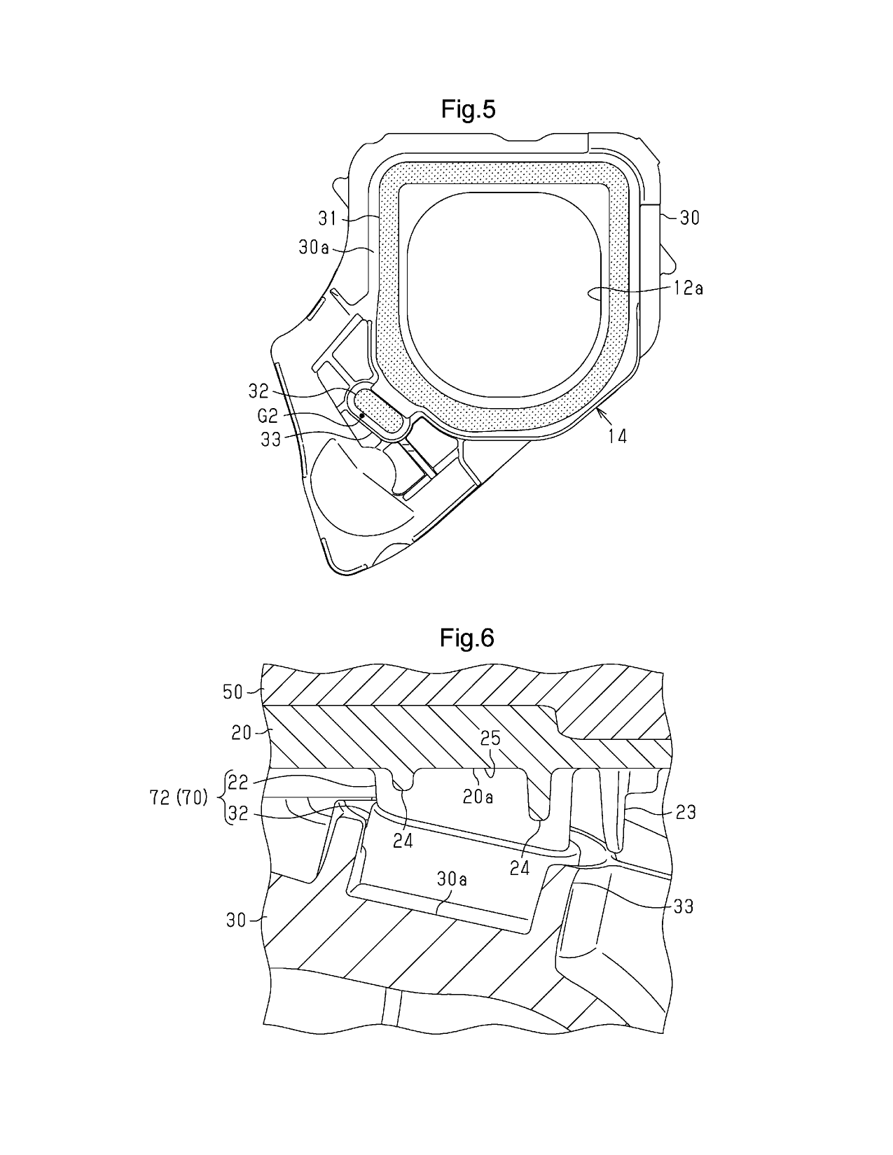

As shown in FIG. 5, the second main weld projection 31 is annular and extends around the connection hole 12a. The second main weld projection 31 is greater in width than the first main weld projection 21. The second auxiliary weld projection 32 is arranged on the inner portion of the curved passage 14 with respect to the curvature direction of the curved passage 14 at a position separated from the second main weld projection 31 in the radially outward direction of the curved passage 14. The second auxiliary weld projection 32 has a cross section orthogonal to the longitudinal direction of the curved passage 14. The cross section of the second auxiliary weld projection 32 has the form of a rectangle having rounded corners and long sides extending in the peripheral direction of the second main weld projection 31. The second auxiliary weld projection 32 is greater than the first auxiliary weld projection 22 in both long side and short side. In FIG. 5, dot shading indicates a weld surface of each of the second main weld projection 31 and the second auxiliary weld projection 32.

The second segmental body 30 includes a second peripheral rib 33 covering the second auxiliary weld projection 32 from sideward. The second peripheral rib 33 includes a portion covering the second auxiliary weld projection 32 from the side opposite to the second main weld projection 31 and a portion covering two longitudinal ends of the second auxiliary weld projection 32. The second peripheral rib 33 is not arranged between the second auxiliary weld projection 32 and the second main weld projection 31. The second peripheral rib 33 is entirely separated from the second auxiliary weld projection 32 by a gap G2.

As shown in FIG. 3, in the main weld part 71, the first main weld projection 21 and the second main weld projection 31 are in contact with each other along the entire perimeter and joined to each other by vibration welding. In the auxiliary weld part 72, the first auxiliary weld projection 22 and the second auxiliary weld projection 32 are in contact with each other and joined to each other by vibration welding.

### Structure of Connection Projection 24

As shown in FIG. 4, the first segmental body 20 includes multiple connection projections 24 connecting the first main weld projection 21 to the first auxiliary weld projection 22. In an example, the first segmental body 20 includes two connection projections 24 separated from each other in the peripheral direction of the curved passage 14. The two connection projections 24 are connected to two longitudinal ends of the first auxiliary weld projection 22. The connection projections 24 project downward from a lower surface of the peripheral edge 20a. The connection projections 24 linearly extend in the radial direction of the curved passage 14.

As shown in FIG. 6, a projection amount of each of the two connection projections 24 from the peripheral edge 20a is less than a projection amount of the first auxiliary weld projection 22 from the peripheral edge 20a. The projection amount differs between the two connection projections 24. In the present embodiment, the projection amount of the first auxiliary weld projection 22 from the peripheral edge 20a gradually increases from a first longitudinal end of the first auxiliary weld projection 22 toward a second longitudinal end located opposite from the first longitudinal end. This structure is caused by a distal surface of the second auxiliary weld projection 32, before being welded, that is inclined from a planar direction of the peripheral edge 20a. The connection projection 24 that is connected to a second end of the first auxiliary weld projection 22 has a larger projection amount from the peripheral edge 20a than the connection projection 24 that is connected to a first end of the first auxiliary weld projection 22.

### Structure of Flash Trap 25

As shown in FIGS. 3 and 6, the first segmental body 20 includes a flash trap 25 that captures flash formed during welding of the weld portion 70. When resin is melted and then partially solidified, flash is formed around the weld portion 70. The flash trap 25 is formed of the first main weld projection 21, the first auxiliary weld projection 22, and the two connection projections 24. The flash trap 25 is a recess that is open toward the second segmental body 30. As shown in FIG. 3, the gap G1, which is located between the first peripheral rib 23 and the first auxiliary weld projection 22, and the gap G2, which is located between the second peripheral rib 33 and the second auxiliary weld projection 32, are used as flash traps differing from the flash trap 25.

### Structure of the Weld Portion 80 and the Weld Portion 90

As shown in FIG. 2, the weld portion 80 includes an annular projection of the second segmental body 30 and an annular projection of the third segmental body 40 that are opposed and welded to each other.

The weld portion 90 includes a projection of the first segmental body 20 and a projection of the fourth segmental body 50 that are opposed and welded to each other.

The weld portion 90 includes a main weld part 91 and an auxiliary weld part 92. The main weld part 91 annularly extends along the periphery of the border between the first segmental body 20 and the fourth segmental body 50. The main weld part 91 seals the border between the first segmental body 20 and the fourth segmental body 50 along the entire perimeter of the curved passage 14. The auxiliary weld part 92 is arranged on the inner portion of the curved passage 14 with respect to the curvature direction of the curved passage 14 at a position separated from the main weld part 91 in the radially outward direction of the curved passage 14. The auxiliary weld part 92 joins the first segmental body 20 and the fourth segmental body 50. The auxiliary weld part 92 does not seal the border between the first segmental body 20 and the fourth segmental body 50.

The main weld part 91 includes a section extending along the guide inlet 11a arranged at the side opposite from the main weld part 71 in a welding direction of the first segmental body 20 and the fourth segmental body 50. The auxiliary weld part 92 and the auxiliary weld part 72 are located at opposite sides in the welding direction of the first segmental body 20 and the fourth segmental body 50. The auxiliary weld part 72, in which the first segmental body 20 is welded to the second segmental body 30, and the auxiliary weld part 92, in which the first segmental body 20 is welded to the fourth segmental body 50, are arranged at the inner portion of the curved passage 14 with respect to the curvature direction of the curved passage 14.

### Effect of the Present Embodiment

When the curved passage 14 receives bending stress that acts to decrease the curvature of the curved passage 14, the bending stress is likely to concentrate on the inner portion of the curved passage 14 with respect to the curvature direction of the curved passage 14. As shown in FIG. 2, for example, when vibration of the throttle body 100 causes downward external force F to act on the guide pipe 12, significant bending stress acts on the curved passage 14.

In the intake manifold 10 of the present embodiment, the auxiliary weld part 72 is arranged on the inner portion of the curved passage 14 with respect to the curvature direction of the curved passage 14 at a position separated from the main weld part 71 in the radially outward direction of the curved passage 14. Thus, in the inner portion of the curved passage 14, the welding strength of the weld portion 70 is increased by both the main weld part 71 and the auxiliary weld part 72. This reduces concentration of stress on the inner portion of the curved passage 14 when the curved passage 14 receives bending stress that acts to decrease the curvature of the curved passage 14. Accordingly, separation is less likely to occur in the weld portion 70.

The main weld part 71 seals the border between the first segmental body 20 and the second segmental body 30. Therefore, it is preferable to limit the occurrence of separation in the main weld part 71 so that the intake manifold 10 maintains the function of supplying intake air. The auxiliary weld part 72, which is arranged at a position separated from the main weld part 71 in the radially outward direction of the curved passage 14, does not seal the border. With this structure, even when separation occurs in the auxiliary weld part 72 due to the bending stress, the intake manifold 10 maintains the function as long as separation does not occur in the main weld part 71.

### Advantages of the Present Embodiment

(1) The intake manifold 10 includes the curved passage 14 extending in a curved manner. The curved passage 14 includes the first segmental body 20 and the second segmental body 30 that are separate in the longitudinal direction of the curved passage 14 and are welded together by the weld portion 70. The weld portion 70 includes the main weld part 71 and the auxiliary weld part 72. The main weld part 71 annularly extends in a peripheral direction of the curved passage 14. The auxiliary weld part 72 is arranged on the inner portion of the curved passage 14 with respect to the curvature direction of the curved passage 14 at a position separated from the main weld part 71 in the radially outward direction of the curved passage 14.

This structure, which has the effect described above, limits the adverse effect on the function of the intake manifold 10.

(2) The first segmental body 20 includes the connection projections 24 connecting the first main weld projection 21 to the first auxiliary weld projection 22.

In this structure, the connection projections 24, which connect the first main weld projection 21 to the first auxiliary weld projection 22, increases the rigidity of the first main weld projection 21 and the first auxiliary weld projection 22. This limits deformation of the first main weld projection 21 and the first auxiliary weld projection 22 when the curved passage 14 receives bending stress that acts to decrease the curvature of the curved passage 14. Accordingly, separation is even less likely to occur in the weld portion 70.

(3) The first segmental body 20 includes the two connection projections 24 separated from each other in the peripheral direction of the curved passage 14. The first segmental body 20 includes the flash trap 25 formed of the first main weld projection 21, the first auxiliary weld projection 22, and the two connection projections 24. The flash trap 25 captures flash formed during welding of the weld portion 70.

For example, if the first main weld projection 21 and the first auxiliary weld projection 22 are connected by a single connection projection 24 extending in the peripheral direction, the connection projection 24 will be arranged in space between the first main weld projection 21 and the first auxiliary weld projection 22. With this structure, as the connection projection 24 is arranged in a larger region, flash formed around the weld portion 70 during welding of the weld portion 70 is less likely to be discharged between the first main weld projection 21 and the first auxiliary weld projection 22. When flash remains on the weld surface of the weld portion 70 due to insufficient discharging of flash, the strength of the weld portion 70 may be decreased.

In this regard, in the structure of the embodiment, the first segmental body 20 includes the flash trap 25 formed of the first main weld projection 21, the first auxiliary weld projection 22, and the multiple connection projections 24. Thus, the above-described shortcoming is less likely to arise.

(4) The cross section of the auxiliary weld part 72 orthogonal to the longitudinal direction of the curved passage 14 has the form of a polygon having rounded corners.

This structure reduces concentration of stress on the auxiliary weld part 72 when the curved passage 14 receives bending stress that acts to decrease the curvature of the curved passage 14. Accordingly, separation is less likely to occur in the weld portion 70.

(5) The auxiliary weld part 72 is arranged on only the inner portion of the curved passage 14 with respect to the curvature direction of the curved passage 14.

This structure limits, for example, increases in the size of the weld portion 70 in the radial direction of the curved passage 14 as compared to a structure in which the auxiliary weld part 72 is arranged on an outer portion of the curved passage 14 in addition to the inner portion of the curved passage 14. Thus, increases in the size of the intake manifold 10 are limited.

(6) The curved passage 14 includes the first segmental body 20 including the surge tank 11 and the second segmental body 30 including the guide pipe 12.

In this structure, bending stress is likely to act on the guide pipe 12 caused by vibration of the throttle body 100, the stress is likely to concentrate on the inner portion of the curved passage 14 in the curvature direction of the curved passage 14. In this regard, in the intake manifold 10, the auxiliary weld part 72 is arranged on the inner portion of the curved passage 14 in the curvature direction of the curved passage 14. Thus, even when vibration occurs as described above, occurrence of separation in the weld portion 70 is limited.

### Modified Examples

The present embodiment may be modified as described below. The present embodiment and the following modified examples can be combined as long as the combined modified examples remain technically consistent with each other.

The curved passage 14 is not limited to the structure including the surge tank 11 and the guide pipe 12. The curved passage 14 may be a portion of the intake manifold 10 extending in a curved manner, as long as segmental bodies are welded together by the weld portion 70. In an example, the curved passage 14 may include the segmental pipes 13.

The auxiliary weld part 72 may extend along the main weld part 71 in the shape of C or may annularly extend along the entire perimeter of the main weld part 71. The auxiliary weld part 72 may be multiple auxiliary weld parts 72 arranged separated from each other in the peripheral direction of the curved passage 14. The auxiliary weld part 72 may be arranged on the outer portion of the curved passage 14 with respect to the curvature direction of the curved passage 14. In this case, when bending stress is applied to the curved passage 14 so as to increase the curvature of the curved passage 14, concentration of stress on the outer portion of the curved passage 14 is reduced. Accordingly, separation is less likely to occur in the weld portion 70.

The cross section of the auxiliary weld part 72 may be circular or may have the form of any polygon having rounded corners.

The cross section of the auxiliary weld part 72 may have any shape with no rounded corners.

The first segmental body 20 may include three or more connection projections 24 separated from each other in the peripheral direction of the curved passage 14. In this case, the first segmental body 20 may include multiple flash traps 25.

The first segmental body 20 may include a single connection projection 24. In this case, the connection projection 24 may be elongated in the peripheral direction of the curved passage 14. In this modified example, the first segmental body 20 does not include the flash trap 25.

The connection projections 24 may be omitted from the first segmental body 20.

The second segmental body 30 may include a connection projection connecting the second main weld projection 31 to the second auxiliary weld projection 32.

In the present embodiment, the guide pipe 12 includes the second segmental body 30 and the third segmental body 40. However, the guide pipe 12 does not have to be separate from each other in a longitudinal direction of the guide pipe 12. In this case, the guide pipe 12 entirely corresponds to a “second segmental body.”

The intake manifold 10 may be used as an intake manifold of a V-shaped internal combustion engine or a straight internal combustion engine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An intake manifold comprising:
a curved passage extending in a curved manner, wherein
the curved passage includes a first segmental body and a second segmental body that are separate from each other in a longitudinal direction of the curved passage and are welded together by a weld portion, and
the weld portion includes
a main weld part annularly extending in a peripheral direction of the curved passage, and
an auxiliary weld part arranged on an inner portion of the curved passage with respect to a curvature direction of the curved passage at a position separated from the main weld part in a radially outward direction of the curved passage.

2. The intake manifold according to claim 1, wherein
the main weld part includes a main weld projection arranged on the first segmental body and configured to be welded to the second segmental body,
the auxiliary weld part includes an auxiliary weld projection arranged on the first segmental body and configured to be welded to the second segmental body, and
the first segmental body includes a connection projection configured to connect the main weld projection to the auxiliary weld projection.

3. The intake manifold according to claim 2, wherein
the connection projection includes multiple connection projections separated from each other in the peripheral direction, and
the main weld projection, the auxiliary weld projection, and the connection projections form a flash trap configured to capture flash during welding of the weld portion.

4. The intake manifold according to claim 1, wherein the auxiliary weld part has a cross section that is orthogonal to the longitudinal direction of the curved passage and has a form of a polygon having a rounded corner.

5. The intake manifold according to claim 1, wherein the auxiliary weld part is arranged on only the inner portion of the curved passage with respect to the curvature direction.

6. The intake manifold according to claim 1, further comprising:
a surge tank; and
a guide pipe extending and bending from the surge tank, the guide pipe being configured to be connected to a throttle body, wherein
the surge tank includes the first segmental body, and
the guide pipe includes the second segmental body.
